(19) United States
(12) Patent Application Publication
(10) Pub. No.: US 2026/0205903 A1
(43) Pub. Date: Jul. 16, 2026

(54) METHOD AND APPARATUS FOR IMPROVING RRC RE-ESTABLISHMENT USING LOW LAYER MOBILITY IN NEXT-GENERATION MOBILE COMMUNICATION SYSTEM

(71) Applicant: Samsung Electronics Co., Ltd., Suwon-si, Gyeonggi-do (KR)

(72) Inventors: June HWANG, Suwon-si (KR); Seungri JIN, Suwon-si (KR)

(21) Appl. No.: 19/132,157

(22) PCT Filed: Nov. 16, 2023
(86) PCT No.: PCT/KR2023/018475

§ 371 Date: May 22, 2025

(30) Foreign Application Priority Data
Nov. 23, 2022 (KR) 10-2022-0158686

(51) Int. Cl. H04W 36/00; H04W 76/18

(52) U.S. Cl. CPC H04W 36/00835; H04W 76/18

(57) ABSTRACT

The present disclosure relates to a 5G or 6G communication system for supporting a higher data transmission rate. According to an embodiment of the present disclosure, a UE may carry out access to another pregiven target cell in case of a wireless connection failure or a handover failure. Accordingly, the delay time due to an attempt of the UE to reconnect to a network may be reduced. Particularly, disclosed is a method for the UE in a wireless communication system, the method comprising the steps of: receiving, from a base station, a radio resource control (RRC) message including lower layer triggered mobility (LTM) configuration information; if a wireless connection failure is detected, performing a cell selection procedure; and on the basis of the LTM configuration information, and a cell selected by the cell selection procedure, determining whether or not to apply the LTM configuration information to the selected cell.

### TECHNICAL FIELD

The disclosure relates to an operation of a UE in a mobile communication system. Specifically, the disclosure relates to a radio resource control (RRC) layer connection establishment technology of the UE.

### BACKGROUND ART

A 5G mobile communication technology defines wide frequency bands to allow a fast transmission speed and a new service and can be implemented not only in a frequency band equal to or lower than 6 GHZ (‘Sub 6 GHz’) such as 3.5 gigahertz (GHz) but also in ultra-high frequency band (‘Above 6 GHz’) called a millimeter wave (mmWave) such as 28 GHz and 39 GHz. Further, in the case of a 6G mobile communication technology called a system of beyond 5G, implementation in terahertz bands (for example, bands such as 95 GHz to 3 THz) is considered to achieve a transmission rate 50 times faster than the 5G mobile communication technology and ultra-low latency reduced to 1/10.

At the beginning of 5G mobile communication technology, for the purposes of supporting an ultra-wideband service (enhanced mobile broadband: eMBB) and services for ultra-reliable low-latency communications (URLLC) and massive machine-type communications (mMTC) and meeting performance requirements, the standardization has been progressed for beamforming for mitigating propagation path loss and increasing a propagation delivery distance in an ultra-high frequency band, massive multiple-input multiple-output (massive MIMO), supporting of various numerologies the dynamic operation of slot formats for efficiently using ultra-high frequency resources (operation of a plurality of subcarrier spacings and the like), initial access technology for supporting multi-beam transmission and a broadband, the definition and operation of a bandwidth part (BWP), a new channel coding method such as a low density parity check (LDPC) code for large-capacity data transmission and a Polar code for high-reliable transmission of control information, L2 pre-processing, network slicing that provides a dedicated network specialized for a specific service, and the like.

Currently, the discussion on the improvement of initial 5G mobile communication technology and performance enhancement thereof is being conducted in consideration of services that the 5G mobile communication technology intended to support, and the physical layer standardization is being progressed for vehicle-to-everything (V2X) for helping an autonomous vehicle in driving determination, based on location and state information that the vehicle transmits, so as to increase convenience of the user, new radio unlicensed (NR-U) that aims at a system operation meeting requirements according to various regulations in an unlicensed band, NR UE low power consumption technology (UE power saving), a non-terrestrial network (NTN) corresponding to direct communication between the UE and a satellite for securing the coverage in an area in which communication with a terrestrial network is not possible, location measurement (positioning), and the like.

Further, the standardization is also being progressed for wireless interface architecture/protocol fields for technology such as an intelligent factory (industrial Internet of things: IIoT) for supporting a new service through a link and convergence with other industrials, an integrated access and backhaul (IAB) that provides a node for expanding a network service area by integratively supporting a wireless backhaul link and an access link, mobility enhancement technology including conditional handover and dual active protocol stack (DAPS) handover, and 2-step random access (2-step RACH for NR) that simplifies a random access procedure, and standardization of system architecture/service fields is also in progress for 5G baseline architecture (for example, service-based architecture or service-based interface) for grafting network function virtualization (NFV) on software-defined networking (SDN) technology, mobile edge computing (MEC) that receives a service based on the UE location, and the like.

When the 5G mobile communication system is commercialized, connected devices which are growing explosively will be connected to a communication network, and accordingly, it is expected to enhance functions and performance of the 5G mobile communication system and need an integrated operation of the connected devices. To this end, new research is scheduled to be conducted on improvement of the performance and reduction in complexity for 5G using extended reality (XR) for efficiently supporting augmented reality (AR), virtual reality (VR), mixed reality (MR), artificial intelligence (AI), and machine learning (ML), and the like, supporting of an AI service, supporting of a metaverse service, drone communication, and the like.

Further, the development of the 5G mobile communication system may be the foundation of the development of not only multi-antenna transmission technology such as a new waveform for securing the coverage in a terahertz band of 6G mobile communication technology, full dimensional multi input multi output (FD-MIMO), an array antenna, and a large scale antenna, a high-dimensional spatial multiplexing technology using metamaterial-based lens and antennas, and orbital angular momentum (OAM) in order to improve the coverage of signals in terahertz bands, and reconfigurable intelligent surface (RIS) technology, but also full duplex technology for improving the frequency efficiency of 6G mobile communication technology and enhancing the system network, AI-based communication technology that uses satellites and artificial intelligence (AI) from the design stage and internalize end-to-end AI supporting functions to realize system optimization, and next-generation distributed computing technology that realizes a service having complexity that exceeds the limits of UE calculation capability by using ultra-high performance communication and computing resources.

As described above, it is possible to provide various services according to the development of the mobile communication system, and thus a method of effectively providing the services is needed.

### DISCLOSURE

### Technical Problem

When the UE fails in the wireless connection or handover, a RRC reestablishment procedure should be performed. In this case, separate data transmission/reception delay is generated, and a procedure for exchanging signals with the network is needed. The disclosure proposes a method of reducing a time for the UE to access the network through one RRC configuration application without such a procedure.

### Technical Solution

In the disclosure to solve the problem, a method of processing a control signal in a wireless communication system includes receiving a first control signal transmitted from a base station, processing the received first control signal, and transmitting a second control signal generated based on the processing to the base station.

Specifically, according to an embodiment of the disclosure, a method of a terminal in a wireless communication system may be provided. The method includes receiving a radio resource control (RRC) message including lower layer triggered mobility (LTM) configuration information from a base station, performing a cell selection procedure in case that wireless connection failure is detected, and based on the LTM configuration information and a cell selected by the cell selection procedure, determining whether to apply the LTM configuration information to the selected cell.

According to another embodiment of the disclosure, a method of a base station in a wireless communication system may be provided. The method includes identifying candidate cells capable of configuring lower layer triggered mobility (LTM) for a terminal and LTM configuration information on each of the candidate cells, generating a radio resource control (RRC) message including candidate cell IDs and the LTM configuration information on each of the candidate cells, and transmitting the RRC message including the LTM configuration information to the terminal.

According to another embodiment of the disclosure, a terminal in a wireless communication system may be provided. The terminal includes a transceiver and a controller, wherein the controller is configured to receive a radio resource control (RRC) message including lower layer triggered mobility (LTM) configuration information from a base station, perform a cell selection procedure in case that wireless connection failure is detected, and based on the LTM configuration information and a cell selected by the cell selection procedure, determine whether to apply the LTM configuration information to the selected cell.

According to another embodiment of the disclosure, a base station in a wireless communication system may be provided. The base station includes a transceiver and a controller, wherein the controller is configured to identify candidate cells capable of configuring lower layer triggered mobility (LTM) for a terminal and LTM configuration information on each of the candidate cells, generate a radio resource control (RRC) message including candidate cell IDs and the LTM configuration information on each of the candidate cells, and transmit the RRC message including the LTM configuration information to the terminal.

### Advantageous Effects

According to an embodiment of the disclosure, an arbitrary UE may access another pregiven target cell when a wireless connection fails or handover fails. Accordingly, it is possible to reduce a delay time due to attempt of the re-access to the network by the UE.

### DESCRIPTION OF DRAWINGS

FIG. 1 is a diagram illustrating the structure of a long term evolution (LTE) system according to an embodiment of the disclosure.

FIG. 2 is a diagram illustrating a wireless protocol structure of the LTE system according to an embodiment of the disclosure.

FIG. 3 is a diagram illustrating the structure of a next-generation mobile communication system according to an embodiment of the disclosure.

FIG. 4 is a diagram illustrating a wireless protocol structure of a next-generation mobile communication system according to an embodiment of the disclosure.

FIG. 5 is a diagram illustrating an example of the mobile communication system according to an embodiment of the disclosure.

FIG. 6 is a diagram illustrating an example of the UE operation in a situation where only an LTM configuration is given according to an embodiment of the disclosure.

FIG. 7 is a diagram illustrating an example of the UE operation in a situation where the LTM configuration and a conditional handover configuration are given according an embodiment of the disclosure.

FIG. 8 is a diagram illustrating an example of the UE operation in a situation where the LTM configuration and the conditional handover configuration are given according an embodiment of the disclosure.

FIG. 9 is a diagram illustrating an example of the UE operation in a situation where the LTM configuration and the conditional handover configuration are given according an embodiment of the disclosure.

FIG. 10 is a block diagram illustrating the structure of the UE according to an embodiment of the disclosure.

FIG. 11 is a block diagram illustrating the structure of the BS according to an embodiment of the disclosure.

### MODE FOR DISCLOSURE

Hereinafter, the operation principle of the disclosure will be described in detail with reference to the accompanying drawings. In the following description of the disclosure, when it is determined that detailed description for related known functions or configurations may unnecessarily obscure the subject matter of the disclosure, the detailed description will be omitted. The terms as described below are defined in consideration of the functions in the embodiments, and the meaning of the terms may vary according to the intention of a user or operator, convention, or the like. Therefore, the definitions of the terms should be made based on the contents throughout the specification.

Terms for identifying access nodes, terms referring to network entities, terms referring to messages, terms referring to interfaces between network entities, terms referring to various pieces of identification information, and the like, which are used in the following description, are exemplified for convenience of description. Accordingly, the disclosure is not limited to the following terms and other terms having the same technical meaning may be used.

Hereinafter, a base station (BS) is the entity that allocates resources to a user equipment (UE), and may be at least one of a gNode B, an eNode B, a Node B, a base station (BS), a radio access unit, a BS controller, or a node on a network. The UE may include a user equipment (UE), a mobile station (MS), a cellular phone, a smart phone, a computer, and a multimedia system capable of performing a communication function. In the disclosure, downlink (DL) refers to a wireless transmission path of a signal which the BS transmits to the UE, and uplink (UL) refers to a wireless transmission path of a signal which the UE transmits to the BS. Further, hereinafter, an LTE or LTE-A system may be described as an example, but embodiments of the disclosure can be applied to other communication systems having a similar technical background or channel form. For example, 5G mobile communication technology (5G, new radio, or NR) developed after LTE-A may be included in systems to which the embodiments of the disclosure can be applied, and the 5G below may be the concept including the existing LTE and LTE-A, and similar other services. The disclosure can be applied to other communication systems through some modifications without departing from the scope of the disclosure on the basis of determination by those skilled in the art. It may be understood that each block of the processing flowchart illustrations and combinations of the flowchart illustrations can be implemented by computer program instructions.

These computer program instructions may be installed in a general-purpose computer, special-purpose computer, or processor of other programmable data-processing apparatus, such that the instructions which execute on the computer or the processor of other programmable data-processing apparatus generate a means for performing the functions specified in the flowchart block(s). These computer program instructions may also be stored in a computer-available or computer-readable memory that can direct a computer or other programmable data-processing apparatus in order to implement to a function in a particular manner such that the instructions stored in the computer-available or computer-readable memory produce an article of manufacture including instructions for implementing the function specified in the flowchart block(s). The computer program instructions may also be loaded onto a computer or other programmable data-processing apparatus to cause a series of operational steps to be performed on the computer or other programmable data-processing apparatus to produce a computer-implemented process such that the instructions executed on the computer or other programmable data-processing apparatus provide steps for implementing the functions specified in the flowchart block(s).

Further, each block may represent a portion of a module, a segment, or a code, which includes one or more executable instructions for implementing the specified logical function(s). It should also be noted that, in some alternative implementation examples, the functions mentioned in the blocks may occur out of the order. For example, two blocks shown in succession may, in fact, be executed substantially simultaneously, or the blocks may sometimes be executed in the reverse order, depending upon the functionality involved. The term ‘unit’ (or ‘~er’) used in the embodiments refers to a software or hardware component such as a field-programmable gate array (FPGA) or an application-specific integrated circuit (ASIC), and the ‘unit’ (or ‘~er’) may play roles. However, the ‘unit’ (or ‘~er’) is not limited to software or hardware. The ‘unit’ (or ‘~er’) may be configured to be present in an addressable storage medium, and may also be configured to run on one or more processors. Accordingly, for example, the ‘unit’ (or ‘~er’) includes software components, object-oriented software components, components such as class components and task components, processors, functions, attributes, procedures, subroutines, segments of program code, drivers, firmware, microcode, a circuit, data, a database, data structures, tables, arrays, and parameters. Functions provided in the components and the ‘units’ (or ‘~ers’) may be combined into a smaller number of components and the ‘units’ (or ‘~ers’) or divided into a larger number of components and ‘units’ (or ‘~ers’). In addition, the components and the ‘units’ (or ‘~ers’) may be implemented to run on one or more CPUs in a device or secure multimedia card. In embodiments, the ‘units’ (or ‘~ers’) may include one or more processors.

For convenience of description, the disclosure uses terms and names defined in 5GS and NR standards, which are the standards defined by the 3^{rd}-generation partnership project (3GPP) among the existing communication standards. However, the disclosure is not limited by the above terms and names, and may be applied equally to wireless communication networks following other standards. For example, the disclosure may be applied to 3GPP 5GS/NR (5^{th}-generation mobile communication standard).

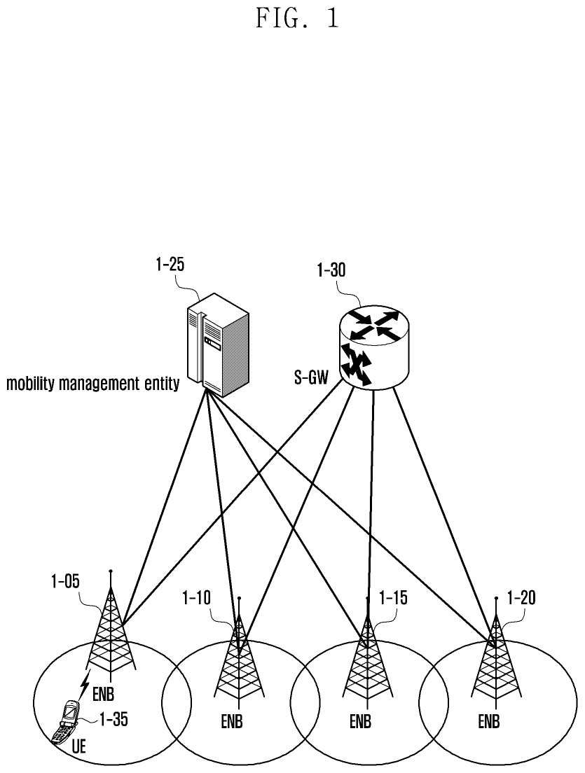

FIG. 1 is a diagram illustrating the structure of a long term evolution (LTE) system according to an embodiment of the disclosure.

Referring to FIG. 1, a radio access network of the LTE system may be constituted by next-generation base stations (Evolved Node Bs (hereinafter, referred to as ENBs), Node Bs, or base stations) 1-05, 1-10, 1-15, and 1-20, a mobility management entity (MME) 1-25, and a serving gateway (S-GW) 1-30. A user equipment (hereinafter, referred to as a UE or a terminal) 1-35 may access an external network through the ENBs 1-05 to 1-20 and the S-GW 1-30.

In FIG. 1, the ENBs 1-05 to 1-20 may correspond to the conventional node Bs of a UMTS system. The ENB is connected to the UE 1-35 through a radio channel, and may play a more complicated role than the conventional node B. In the LTE system, all user traffic including a real-time service such as a voice over IP (VoIP) through an Internet protocol may be served through a shared channel. Accordingly, a device for collecting and scheduling status information such as buffer statuses, available transmission power statuses, and channel statuses of UEs is needed, which is served by the ENBs 1-05 to 1-20. One ENB may generally control a plurality of cells. For example, in order to implement a transmission rate of 100 Mbps, the LTE system may use, for example, orthogonal frequency division multiplexing (OFDM) as the radio access technology in a bandwidth of 20 MHz. Further, an adaptive modulation and coding (AMC) scheme of determining a modulation scheme and a channel coding rate in accordance with the channel status of the UE may be applied. The S-GW 1-30 is a device that provides a data bearer and may generate or remove the data bearer according to the control of the MME 1-25. The MME is a device that serves to perform various control functions as well as a function of managing mobility of the UE and may be connected to a plurality of ENBs.

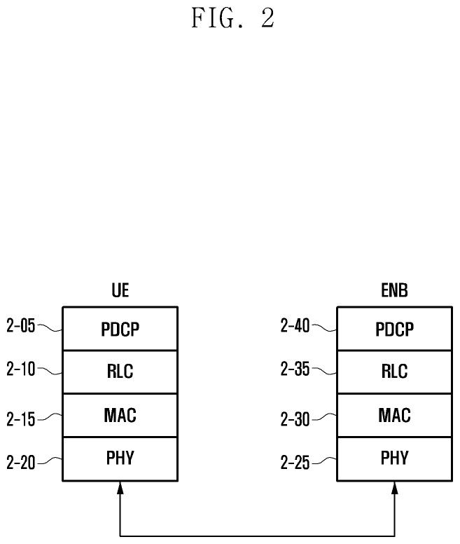

FIG. 2 is a diagram illustrating a wireless protocol structure of the LTE system according to an embodiment of the disclosure.

Referring to FIG. 2, the wireless protocol of the LTE system may be constituted by packet data convergence protocols (PDCPs) 2-05 and 2-40, radio link controls (RLCs) 2-10 and 2-35, medium access controls (MACs) 2-15 and 2-30, respectively, in the UE and the ENB. The PDCP may perform an operation such as IP header compression/restoration. Main functions of the PDCP may be summarized below.
Header compression and decompression function (Header compression and decompression: ROHC only)
User data transmission function (Transfer of user data)
Sequential delivery function (In-sequence delivery of upper layer PDUs at PDCP re-establishment procedure for RLC AM)
Sequence re-arrangement function (For split bearers in DC (only support for RLC AM): PDCP PDU routing for transmission and PDCP PDU reordering for reception)
Duplicate detection function (Duplicate detection of lower layer SDUs at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer-based SDU deletion function (Timer-based SDU discard in uplink)

The radio link controls (RLCs) 2-10 and 2-35 may perform an ARQ operation and the like by reconfiguring a PDCP packet data unit (PDU) to have the proper size. Main functions of the RLC may be summarized below.
Data transmission function (Transfer of upper layer PDUs)
ARQ function (Error Correction through ARQ (only for AM data transfer))
Concatenation, segmentation, and reassembly function (Concatenation, segmentation, and reassembly of RLC SDUs (only for UM and AM data transfer))
Re-segmentation function (Re-segmentation of RLC data PDUs (only for AM data transfer))
Reordering function (Reordering of RLC data PDUs (only for UM and AM data transfer)
Duplication detection function (Duplicate detection (only for UM and AM data transfer))
Error detection function (Protocol error detection (only for AM data transfer))
RLC SDU deletion function (RLC SDU discard (only for UM and AM data transfer))
RLC re-establishment function (RLC re-establishment)

The MACs 2-15 and 2-30 are connected with various RLC layer entities constructed in one UE, and perform an operation for multiplexing RLC PDUs to the MAC PDU and de-multiplexing the RLC PDUs from the MAC PDU. Main functions of the MAC may be summarized below.
Mapping function (Mapping between logical channels and transport channels)
Multiplexing and de-multiplexing function (Multiplexing/de-multiplexing of MAC SDUs belonging to one or different logical channels into/from Transport Blocks (TB) delivered to/from the physical layer on transport channels)
Scheduling information report function (Scheduling information reporting)
HARQ function (Error correction through HARQ)
Function of controlling priority between logical channels (Priority handling between logical channels of one UE)
Function of controlling priority between UEs (Priority handling between UEs by means of dynamic scheduling)
MBMS service identification function (MBMS service identification)
Transport format selection function (Transport format selection)
Padding function (Padding)

The PHY layers 2-20 and 2-25 may perform an operation of channel-coding and modulating higher-layer data, generating an OFDM symbol, and transmitting the OFDM symbol through a radio channel or demodulating and channel-decoding the OFDM symbol received through a radio channel and delivering the demodulated and channel-decoded OFDM symbol to a higher layer.

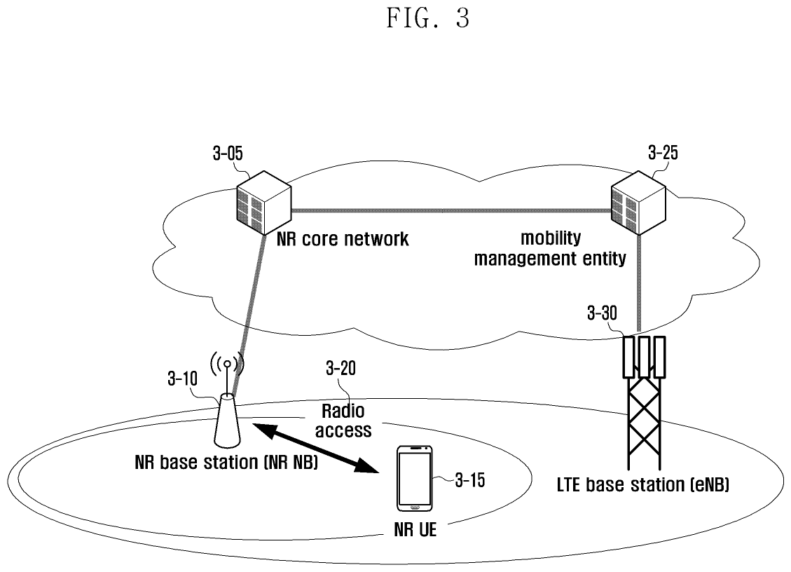

FIG. 3 is a diagram illustrating the structure of a next-generation mobile communication system according to an embodiment of the disclosure.

Referring to FIG. 3, a radio access network of a next-generation mobile communication system (hereinafter, referred to as NR or 5 g) may be constituted by a next-generation base station (new radio Node B, hereinafter, referred to as NR gNB, or NR base station) 3-10 and a next-generation radio core network (new radio core network or NR CN) 3-05. A next-generation radio user terminal (new radio user equipment, NR UE, or NR terminal) 3-15 may access an external network through the NR gNB 3-10 or the NR CN 3-05.

In FIG. 3, the NR gNB 3-10 may correspond to an evolved Node B (eNB) in the conventional LTE system. The NR gNB may be connected to the NR UE 3-15 through a radio channel and may provide better service than the conventional node B. In the next-generation mobile communication system, all user traffic may be served through a shared channel. Accordingly, a device for collecting and scheduling status information such as buffer statuses, available transmission power statuses, and channel statuses of UEs is needed, which is served by the NR NB 3-10. One NR gNB may control a plurality of cells. In the next-generation mobile communication system, in order to implement super-high data transmission compared to general LTE, a bandwidth higher than or equal to the normal maximum bandwidth may be applied. Further, a beamforming technology may be additionally grafted onto the orthogonal frequency division multiplexing (OFDM) as a radio access technology. In addition, an adaptive modulation and coding (AMC) scheme of determining a modulation scheme and a channel coding rate in correspondence to a channel status of the NR UE may be applied. The NR CN 3-05 may perform a function of supporting mobility, configuring a bearer, configuring QoS, and the like. The NR CN is a device that performs various control functions as well as a function of managing mobility for the UE, and may be connected to a plurality of BSs. Further, the next-generation mobile communication system may be linked to the LTE system, and the NR CN may be connected to an MME 3-25 through a network interface. The MME may be connected to an eNB 3-30 that is the LTE BS.

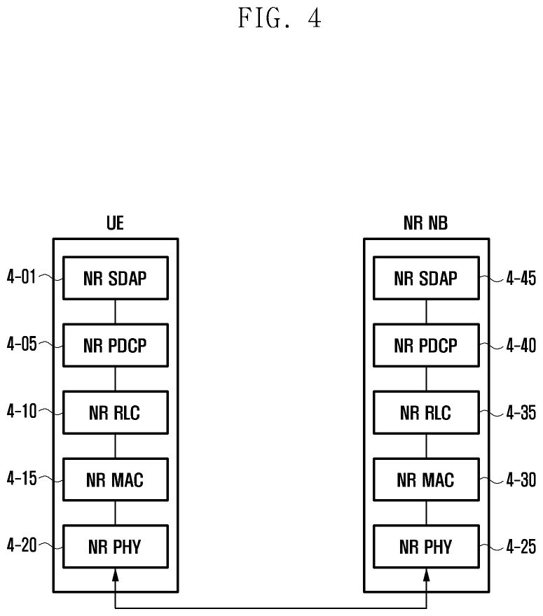

FIG. 4 is a diagram illustrating a wireless protocol structure of a next-generation mobile communication system according to an embodiment of the disclosure.

Referring to FIG. 4, the wireless protocol of the next-generation mobile communication system is constituted by NR service data adaptation protocols (SDAPs) 4-01 and 4-45, NR PDCPs 4-05 and 4-40, NR RLCs 4-10 and 4-35, NR MACs 4-15 and 4-30, and NR PHYs 4-20 and 4-25 in the UE and the NR gNB.

Main functions of the NR SDAPs 4-01 and 4-45 may include some of the following functions.
User data transmission function (transfer of user-plane data)
Function of mapping QoS flow and a data bearer for uplink and downlink (mapping between a QoS flow and a DRB for both DL and UL)
Function of marking a QoS flow ID for uplink and downlink (marking QoS flow ID in both DL and UL packets)
Function of mapping reflective QoS flow to a data bearer for uplink SDAP PDUs (reflective QoS flow to DRB mapping for the UL SDAP PDUs)

For the SDAP layer entity, the UE may receive a configuration indicating whether to use the header of the SDAP layer entity or the function of the SDAP layer entity for each PDCP layer entity, each bearer, or each logical channel through a radio resource control (RRC) message. When the SDAP header is configured, the UE may indicate an update or a reconfiguration of mapping information for uplink and downlink QoS flow and the data bearer to the UE through a non-access stratum (NAS) quality of service (QoS) reflective configuration 1-bit indicator (NAS reflective QoS) and an access stratum (AS) QoS reflective configuration 1-bit indicator (AS reflective QoS) of the SDAP header. The SDAP header may include QoS flow ID information indicating the QoS. The QoS information may be used as data-processing-priority, scheduling information, or the like to support a seamless service.

Main functions of the NR PDCPs 4-05 and 4-40 may include some of the following functions.
Header compression and decompression function (Header compression and decompression: ROHC only)
User data transmission function (Transfer of user data)
Sequential delivery function (In-sequence delivery of upper layer PDUs)
Non-sequential delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU deletion function (timer-based SDU discard in uplink)

In the above description, the reordering function of the NR PDCP entity may be a function of sequentially reordering PDCP PDUs received by a lower layer, based on a PDCP sequence number (SN). The reordering function of the NR PDCP entity may include a function of sequentially delivering reordered data to a higher layer, a function of directly performing delivery without consideration of the order, a function of performing reordering to record lost PDCP PDUs, a function of reporting statuses of the lost PDCP PDUs to a transmitting side, and a function of making a request for retransmitting the lost PDCP PDUs.

Main functions of the NR RLCs 4-10 and 4-35 may include some of the following functions.
Data transmission function (Transfer of upper layer PDUs)
Sequential delivery function (In-sequence delivery of upper layer PDUs)
Non-sequential delivery function (Out-of-sequence delivery of upper layer PDUs)
ARQ function (Error correction through ARQ)
Concatenation, segmentation, and reassembly function (Concatenation, segmentation, and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU deletion function (RLC SDU discard)
RLC re-establishment function (RLC re-establishment)

In the above description, the sequential delivery function (in-sequence delivery) of the NR RLC entity may be a function of sequentially delivering RLC SDUs received from a lower layer to a higher layer. When one RLC SDU is divided into a plurality of RLC SDUs and received, the sequential delivery function (in-sequence delivery) of the NR RLC entity may include a function of reassembling and then delivering the RLC SDUs.

The sequential delivery function (in-sequence delivery) of the NR RLC entity may include a function of reordering the received RLC PDUs, based on an RLC sequence number (SN) or a PDCP sequence number (SN), a function of performing reordering to record lost RLC PDUs, a function of reporting statuses of the lost RLC PDUs to a transmitting side, and a function of making a request for retransmitting the lost RLC PDUs.

The sequential delivery function (in-sequence delivery) of the NR RLC entity may include a function of, if there is a lost RLC SDU, sequentially delivering only RLC SDUs preceding the lost RLC SDU to the higher layer.

The sequential delivery function (in-sequence delivery) of the NR RLC entity may include a function of, if a predetermined timer expires even though there is a lost RLC SDU, sequentially delivering all RLC SDUs received before the timer starts to the higher layer.

The sequential delivery function (in-sequence delivery) of the NR RLC entity may include a function of, if a predetermined timer expires even though there is a lost RLC SDU, sequentially delivering all RLC SDUs received up to now to the higher layer.

The NR RLC entity may process RLC PDUs sequentially in the order of reception regardless of sequence numbers (out-of-sequence delivery) and deliver the RLC PDUs to the NR PDCP entity.

When receiving segments, the NR RLC entity may receive segments stored in the buffer or to be received in the future, reconfigure the segments to be one complete RLC PDU, and then deliver the RLC PDU to the NR PDCP entity.

The NR RLC layer may not include a concatenation function, and the function may be performed by the NR MAC layer, or may be replaced with a multiplexing function of the NR MAC layer.

In the above description, the non-sequential delivery function (out-of-sequence delivery) of the NR RLC entity may be a function of directly delivering RLC SDUs received from the lower layer to the higher layer regardless of the order. When one RLC SDU is divided into a plurality of RLC SDUs and received, the non-sequential delivery function (out-of-sequence delivery) of the NR RLC entity may include a function of reassembling and then delivering the RLC SDUs. The non-sequential delivery function (out-of-sequence delivery) of the NR RLC entity may include a function of storing RLC SNs or PDCP SNs of the received RLC PDUs, ordering the same, and recording lost RLC PDUs.

The NR MACs 4-15 and 4-30 may be connected to a plurality of NR RLC layer entities configured in one UE and main functions of the NR MAC may include some of the following functions.
Mapping function (Mapping between logical channels and transport channels)
Multiplexing and de-multiplexing function (Multiplexing/de-multiplexing of MAC SDUs)
Scheduling information report function (Scheduling information reporting)
HARQ function (Error correction through HARQ)
Function of controlling priority between logical channels (Priority handling between logical channels of one UE)
Function of controlling priority between UEs (Priority handling between UEs by means of dynamic scheduling)
MBMS service identification function (MBMS service identification)
Transport format selection function (Transport format selection)
Padding function (Padding)

The NR PHY layers 4-20 and 4-25 may perform an operation of channel-coding and modulating higher layer data, generating an OFDM symbol, and transmitting the OFDM symbol through a radio channel or demodulating and channel-decoding the OFDM symbol received through the radio channel and delivering the demodulated and channel-decoded OFDM symbol to the higher layer.

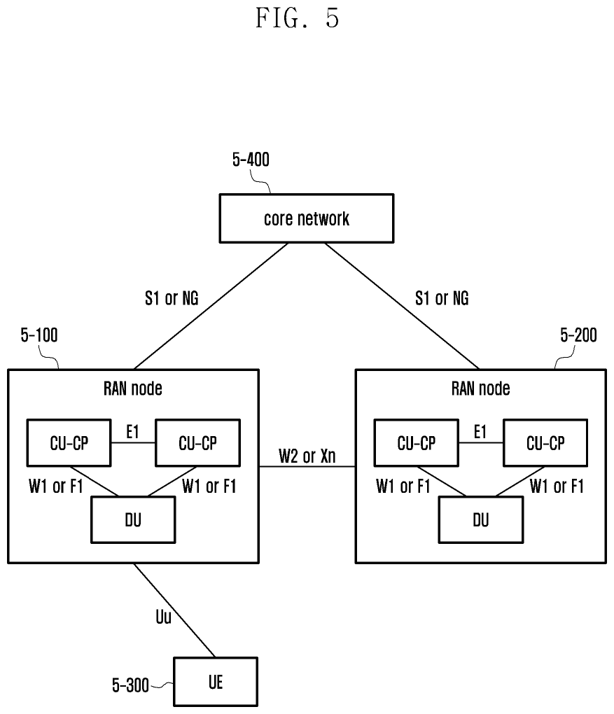

FIG. 5 is a diagram illustrating an example of the mobile communication system according to an embodiment of the disclosure.

Referring to FIG. 5, illustrated radio access network (RAN) nodes 5-100 and 5-200 may be LTE evolved node Bs (eNBs or eNodeBs) connected to a mobile communication core network (CN) such as an evolved packet core (EPC) or a 5G core network (5GC), next generation node Bs (NR gNBs), base stations in a next-generation mobile communication system, or network nodes performing the same or similar functions. Meanwhile, the RAN nodes 5-100 and 5-200 may have functions divided into a centralized unit (CU) and a distributed unit (DU), and the CU may have functions divided into a CU-control plane (CP) and a CU-user plane (UP).

In the disclosure, one RAN node may be constituted by one or more CU-CUPs, one or more CU-UPs, and one or more DUs. Further, one RAN node may be constituted by a CU-CP, a CU-UP, and a DU. For example, one RAN node may be constituted by a CU in which a CU-CP and a CU-UP are implemented together and a DU. Alternatively, one RAN node may be configured in the form of an integrated base station in which a CU-CP, a CU-UP, and a DU are implemented together. Meanwhile, the configuration of the RAN node described above corresponds to only an example, and the disclosure is not limited thereto. One RAN node may be configured by another combination other than the examples.

In the disclosure, a CU and a DU may support the functions of the BS separately. For example, the CU may support functions of a radio resource control (RRC) layer or a packet data convergence protocol (PDCP) layer, and the DU may support functions of a radio link control (RLC) layer, a medium access control (MAC) layer, a physical (PHY) layer, or a radio frequency (RF) layer. Further, the CU and the DU may be connected to each other through an interface between internal BS functions such as a W1 interface or an F1 interface. Meanwhile, detailed information on the functions of each layer supported by the CU and the DU may be referred to FIGS. 2 and 4.

In the disclosure, the CU may be divided into a CU-CP and a CU-UP. In this case, for example, the CU-CP may support functions of the RRC layer or the PDCP (for RRC) layer, and the CU-UP may support functions of a PDCH (for user data transmission) layer. The CU-CP and the CU-UP may be connected through an interface between internal base station functions such as an E1 interface.

In the disclosure, the RAN node or the BS may be implemented in an integrated structure or a distributed structure, and the connection between integrated BSs, between distributed BSs, and between the integrated BS and the distributed BS may be possible. RAN nodes may be connected each other through an interface between BSs such as an X2 interface or an Xn interface. Further, the RAN node and the core network may be connected through an interface a BS and a core network such as an S1 interface or an NG interface.

In the disclosure, the core network may include various network entities (for example, user plane function (UPF), session management function (SMF), access and mobility function (AMF), network exposure function (NEF), application function (AF), or network entities performing other specific functions).

The UPF is a network function (NF) that serves as a user plane in the core network. The UPF may perform a function of mapping a packet of internet protocol (IP) flow to specific QoS flow belonging to a specific protocol data unit (PDU) session on the basis of information (for example, at least one of a packet detection rule (PDF), a forwarding action rule (FAR), a quality of service enforcement rule (QER), or a usage reporting rule (URR)) received from one (for example, SMF) of the control plane NFs.

The SNF is one of the network functions (NFs) that serve as a control plane in the core network. The SMF may transmit information (for example, at least one of a QoS flow indicator (QFI), a QoS profile, a PDR, an FAR, a QER, or a URR) required for guaranteeing quality of service (QoS) to the UPF and the BS. Further, the SMF may determine a UP security policy indicating whether to activate UP confidentiality or UP integrity for all DRBs belonging to the corresponding PDU session in a PDU session establishment procedure and transfer the same to the BS through the AMF.

Meanwhile, the communication system has been described as only an example of communication systems to which the disclosure can be applied, but the disclosure is not limited thereto. That is, embodiments proposed in the disclosure may be applied to and implemented in various communication systems.

In the mobile communication system described above, when the UE fails the wireless connection or the handover, a RRC re-establishment procedure should be performed. In this case, separate data transmission/reception delay is generated, and a procedure for exchanging signals with the network is needed. The disclosure proposes a method of reducing a time for the UE to access the network through one RRC configuration application without such a procedure.

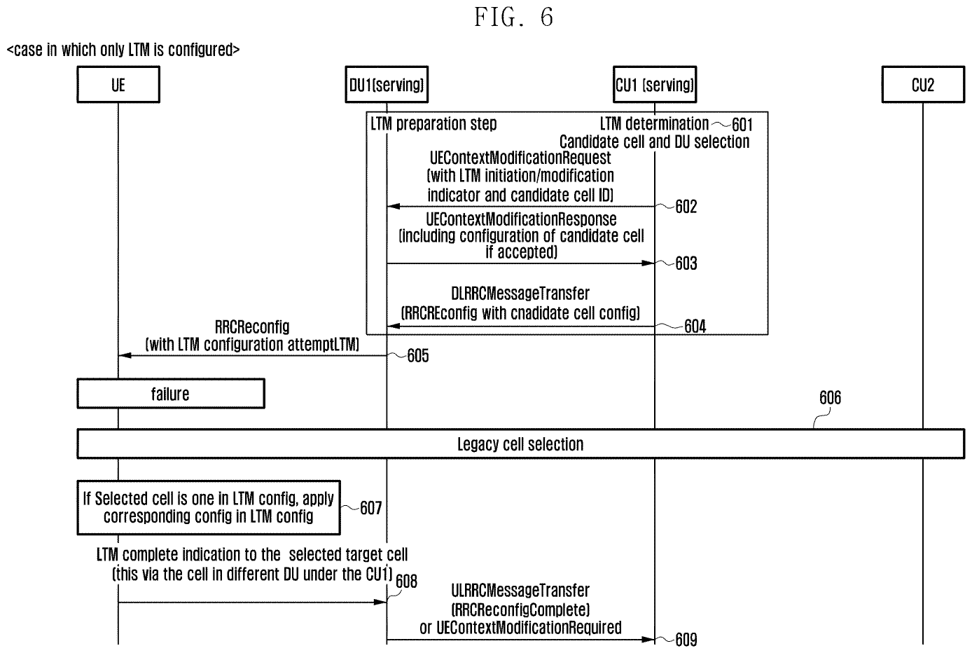

FIG. 6 is a diagram illustrating an example of a UE operation in a situation where only an LTM configuration is given according to an embodiment of the disclosure.

Referring to FIG. 6, signals may be exchanged between a CU and a DU through an F1AP message. In FIG. 6, CU1 and DU1 may be a CU and a DU that serve the current UE. The UE may report L3-based measurement information to the serving CU by a configuration of the serving CU. The serving CU may determine LTM preparation in consideration of the corresponding information. When having determined the LTM preparation, the serving CU may select a candidate cell and a DU that operates the candidate cell in step 601. The serving CU may transfer a message (for example, a UEContextModificationRequest message) including at least one of a candidate cell ID and LTM initiation(start) and/or modification(update) indicators to the DU that operates the selected candidate cell in step 602. The DU receiving the message from the serving CU may determine whether to accept the LTM preparation for the indicated cell. When determining to accept the same, the DU may transfer a message (for example, a UEContextModificationResponse message) including configuration information for the corresponding cell to the CU in step 603. The CU receiving the corresponding configuration information may configure a RRC message (for example, a RRCReconfiguration message), optionally insert the corresponding candidate target cell configuration information received from the DU and additional common configuration information to be configured in the UE into the RRC message as the LTM configuration information, and transmit the RRC message to the UE in steps 604 and 605. For example, the CU may configure a RRC message (for example, a RRCReconfiguration message) including LTM configuration information and transfer a message (for example, a DLRRCMessageTransfer message) including the corresponding RRC message to the DU in step 604. Thereafter, the DU may transmit the corresponding RRC message to the UE in step 605. Meanwhile, it is assumed that the LTM configuration is made only within the same CU in the disclosure. However, the disclosure is not limited thereto.

The corresponding RRCReconfiguration message may include an indicator (for example, an attemptLTM indicator) indicating the performance of a RRCReestablishment improvement operation additionally proposed in the disclosure. For example, the indicator may be included in the RRCReconfiguration message separately from the LTM configuration information or may be included in the LTM configuration information separately from the candidate target cell information. The UE receiving the indicator and the LTM candidate cell configuration may perform cell selection according to the following failure requirements and then perform an operation related to the LTM operation.
Radio link failure of Pcell or
Pcell handover failure or
Compliance check failure of RRCReconfiguration or
Integrity check failure or
Ciphering failure

When one of the failures is generated, the UE may perform a cell selection procedure in step 606. If the selected cell is one of the candidate cells corresponding to the LTM configuration pre-transferred to the UE, the UE may apply the LTM configuration for the corresponding selected cell in step 607. When receiving a UL transmission grant or receiving an indication thereof from the network after applying the LTM configuration, the UE may indicate an LTM completion indication to the candidate cell through corresponding UL resources in step 608. The LTM completion indication may be transmitted through a UL RRC message, a UL MAC CE, or UCI of a physical layer. In addition, the completion indication message may include an indicator indicating that the corresponding LTM operation is an operation according to failure. The selected cell may be a cell included in another DU within the same CU or may be a cell included in the same DU. The DU receiving the completion indication message may transfer a ULRRCMessageTransfer message or a UEContextModificationRequired message to the CU in step 609. In addition, when the configuration information was previously given to the UE, the completion indication message may include an ID indicating a configuration of each candidate cell. In this case, the UE may insert an ID associated with the corresponding selected cell into the completion message indication and transfer the completion message indication to the target cell.

Meanwhile, it is illustrated that steps 601 to 609 of FIG. 6 are sequentially performed, but the disclosure is not limited thereto. Some of steps 601 to 609 of FIG. 6 may be omitted or simultaneously performed.

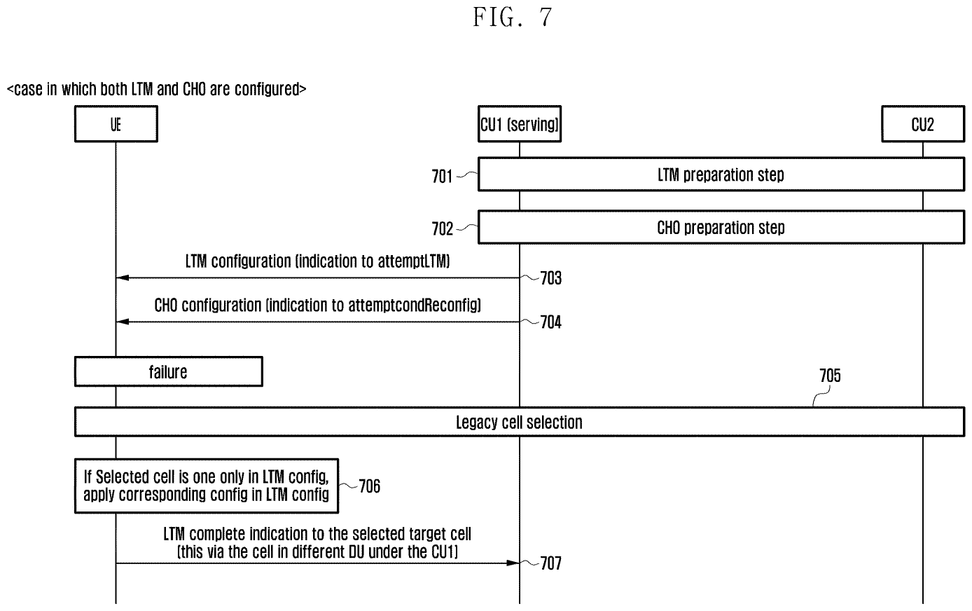

FIG. 7 is a diagram illustrating an example of a UE operation in a situation where an LTM configuration and a conditional handover configuration are given according to an embodiment of the disclosure.

Referring to FIG. 7, in the LTM preparation step (step 701), an operation that is the same as the LTM preparation operation performed between the CU and DU may be performed as described in FIG. 6. Meanwhile, the LTM preparation operation and the candidate cell may be prepared within DUs of an intra CU in which the F1 connection of the serving CU exists.

In the CHO (conditional handover) preparation step (step 702), the service CU may receive configuration information of a candidate cell existing in CU2 via a conditional handover preparation process between the serving CU and other CU2. Alternatively, for the candidate cell within the serving CU, the service CU may make candidate cell configuration information by itself.

When the LTM preparation ends, the serving CU may transfer configuration information of the LTM candidate cell to the UE through a RRC message (for example, a RRCReconfiguration message in step 703. In addition, the serving CU may indicate performance of an improvement method of RRCReestabblishment proposed in the disclosure through an attemptLTM indicator. Moreover, when the CHO preparation ends, the serving CU may transfer configuration information of the CHO candidate cell to the UE through a RRC message (for example, a RRCReconfiguration message) in step 704. Further, when the cell selected by the UE is included in the CHO candidate cells in the failure illustrated in FIG. 6, the serving CU may insert an indicator (For example, an attemptCHO indicator or attemptCondReconfig) indicating the performance of the CHO or that an operation of applying CHO configuration information of the corresponding cell can be performed to the corresponding cell into the RRC message and transmit the RRC message. Meanwhile, the configuration information of the LTM candidate cell and the configuration information of the CHO candidate cell may be included in the same RRC message (for example, RRCReconfiguration message).

The UE receiving the LTM configuration information, attemptLTM, the CHO configuration, and the attemptCHO indicator may perform a cell selection procedure when failure is generated in step 705. For example, the failure may be described below.
Radio link failure of Pcell or
Pcell handover failure or
Compliance check failure of RRCReconfiguration or
Integrity check failure, or
Ciphering failure

When the cell selected through the cell selection procedure is included only in the LTM candidate cell, the UE may apply the LTM configuration of the corresponding cell in step 706. Further, the UE may transfer an LTM performance completion message (or the LTM completion indication) to the network through the corresponding selected cell in step 707. The LTM performance completion message can be transmitted through RRC, MAC CE or UCI as described in FIG. 6. Further, the LTM performance completion message may include an indicator indicating LTM performance through failure.

It is illustrated that steps 701 to 707 of FIG. 7 are sequentially performed, but the disclosure is not limited thereto. Some of steps 701 to 707 of FIG. 7 may be omitted or simultaneously performed.

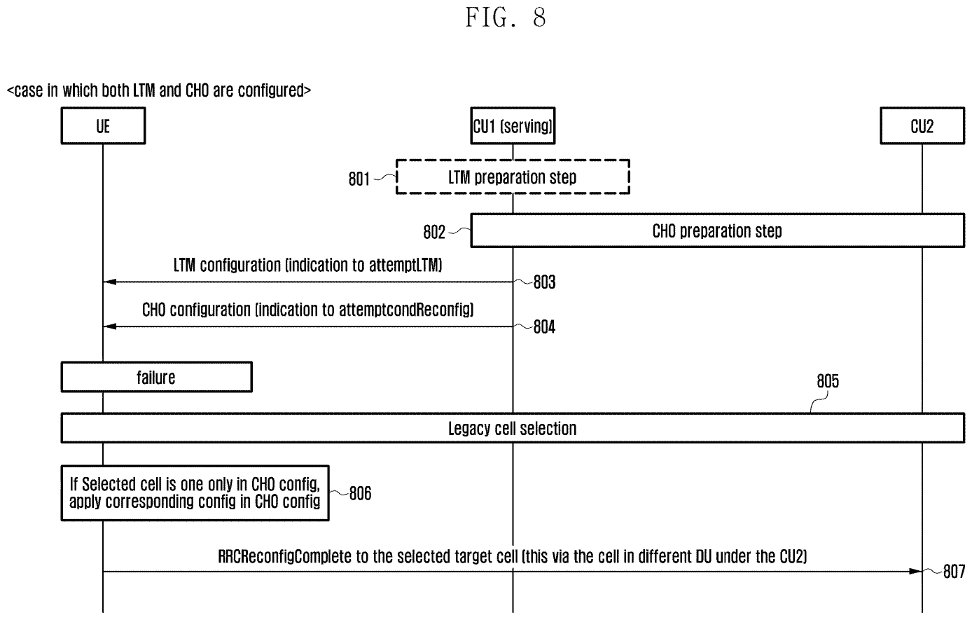

Meanwhile, the cell selected through the cell selection procedure may be included only in a CHO candidate cell. This will be described with reference to FIG. 8.

FIG. 8 is a diagram illustrating an example of a UE operation in a situation where an LTM configuration and a conditional handover configuration are given according to an embodiment of the disclosure.

Steps 801 to 805 of FIG. 8 may be performed in the same manner as steps 701 to 705 of FIG. 7.

When the cell selected through the cell selection procedure is included only in the CHO candidate cell, the UE may apply a CHO configuration of the corresponding cell in step 806. Further, the UE may transfer a CHO performance completion message (or the CHO completion indication) to the network through the corresponding selected cell in step 807. The CHO performance completion message may be a RRC message (for example, a RRCReconfigurationComplete message). In this case, the CHO candidate cell may be an inter CU cell.

It is illustrated that steps 801 to 807 of FIG. 8 are sequentially performed, but the disclosure is not limited thereto. Some of steps 801 to 807 of FIG. 8 may be omitted or simultaneously performed.

Meanwhile, the cell selected by the UE through the cell selection procedure in failure may be included in both the LTM candidate cell and the CHO candidate cell. In this case, the UE may perform the following operation for configuration information to be applied.
Opt 1. Selects one of two pieces of configuration information through UE implementation.
Opt 2. Selects a configuration of LTM.
Opt 3. Selects a configuration of CHO.

Which of Opts 1, 2, and 3 to follow may be determined by the operation of the UE. Alternatively, the network may indicate whether to select the LTM configuration or the CHO configuration. For example, when the network indicates to select the LTM configuration, the UE may select the LTM configuration according to Opt 2. Alternatively, when the network indicates to select the CHO configuration, the UE may select the CHO configuration according to Opt 3. Alternatively, when the network does not make the indication otherwise, the UE may select one of the LTM configuration and the CHO configuration according to Opt 1. The corresponding indicator may be transmitted along with an indicator such as attemptCHO, attemptLTM, or attemptCommon. Alternatively, the network may indicate, to the UE, which configuration is selected through a separate DL RRC message, MAC CE, or DCI. Alternatively, the network may transfer an indicator indicating priorities of the LTM configuration and the CHO configuration to the UE.

The UE may apply the selected configuration. The CHO configuration may be RRCReconfiguration associated with the selected cell. The LTM configuration may be a RRCReconfigration message, a CellGroupConfiguration message, or a specific serving cell configuration for the selected cell. Alternatively, the LTM configuration may be obtained by adding common configuration information that can be applied to other candidate cells to the cellGroupConfig or serving Cellconfiguration.

When the CHO configuration is applied, the UE may perform the inter CU handover. For example, the handover may be performed to a candidate cell in a CU other than the serving CU. When the LTM configuration is applied, candidate cells existing only in DUs within the serving CU may be targets to be selected for the intra CU handover.

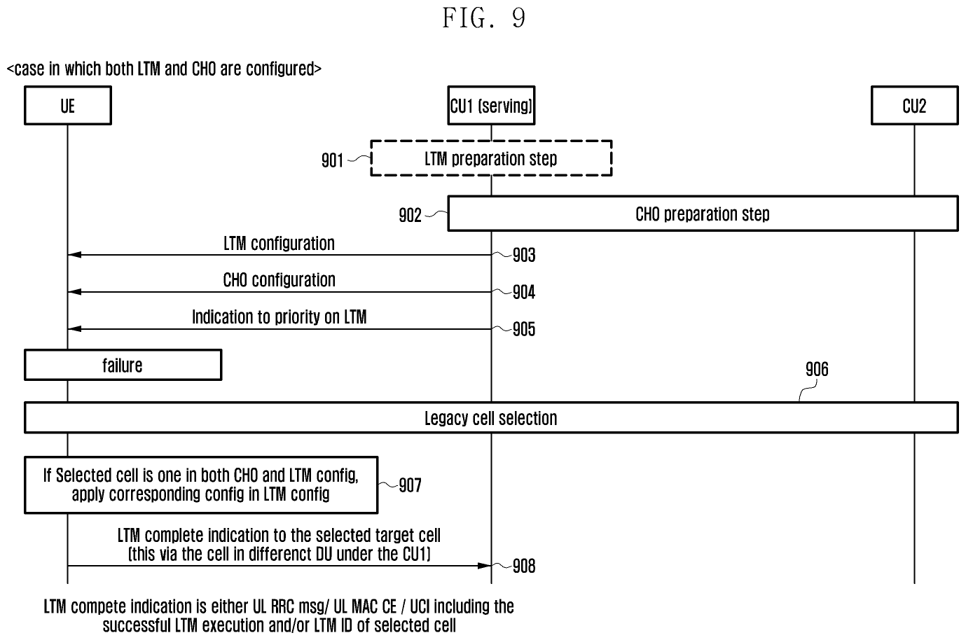

FIG. 9 is a diagram illustrating an example of a UE operation in a situation where an LTM configuration and a conditional handover configuration are given according to an embodiment of the disclosure.

Steps 901 to 904, and step 906 of FIG. 9 may be performed in the same manner as steps 701 to 705 of FIG. 7 and steps 801 to 805 of FIG. 8.

FIG. 9 illustrates an example in which the network indicates that the LTM configuration is preferentially used as the case where the UE selects a configuration to be applied according to Opt 2.

The UE may receive an indication to preferentially use the LTM configuration from the network in step 905. When the selected cell has both the CHO configuration and the LTM configuration in failure, the UE may preferentially select and apply the LTM configuration in step 907. In this case, the selected cell may be a target of the intra CU handover. Further, the UE may transfer an LTM performance completion message (or the LTM completion indication) to the network through the corresponding selected cell in step 908. The LTM performance completion message can be transmitted through RRC, MAC CE or UCI as described in FIG. 6. Further, the LTM performance completion message may include at least one of an indicator indicating LTM performance through failure or an LTM ID of the selected cell.

In another embodiment, the network may transfer one indicator indicating the performance of RRCReestablishment through the LTM and/or CHO to the UE. The above-described embodiment has described the case in which separate indicators attemptLTM and attemptCHO are given individually or simultaneously as an example, but when the LTM configuration and/or CHO configuration are given to the UE and one indicator (for example, attemptCommon) is indicated, the UE may perform an operation of applying candidate cell information of the configuration including the selected cell among LTM and/or CHO candidate cells.

Alternatively, in failure, the UE may perform a procedure of selecting a cell from among LTM candidate cells and/or CHO candidate cells according to an indication of the network.

Alternatively, in failure, the network may transmit or broadcast PCIs and/or ARFCNs of LTM candidate cells to the UE in a dedicated manner as the cell selection candidates, and allow the UE to preferentially select the corresponding cells for cell selection or reselection.

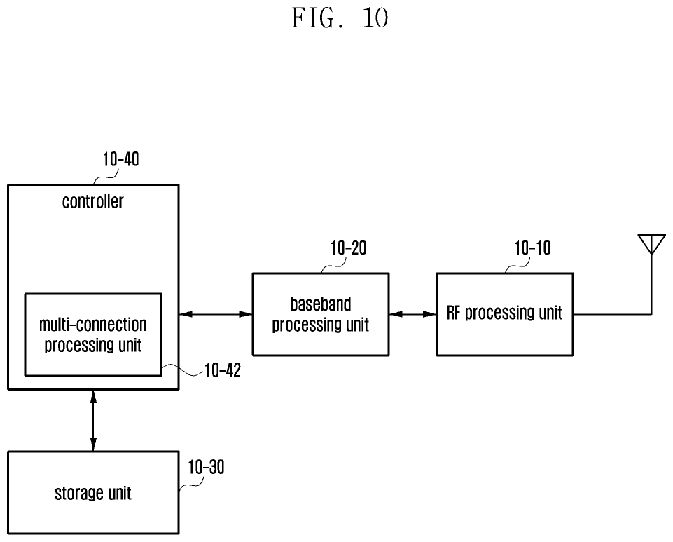

FIG. 10 is a block diagram illustrating the structure of the UE according to an embodiment of the disclosure.

Referring to FIG. 10, the UE may include a radio frequency (RF) processing unit 10-10, a baseband processing unit 10-20, a storage unit 10-30, and a controller 10-40.

The RF processing unit 10-10 performs a function of transmitting and receiving a signal through a radio channel such as converting or amplifying a band of the signal. That is, the RF processing unit 10-10 up-converts a baseband signal provided from the baseband processing unit 10-20 into an RF band signal, transmits the RF band signal through an antenna, and then down-converts the RF band signal received through the antenna into a baseband signal. For example, the RF processing unit 10-10 may include a transmission filter, a reception filter, an amplifier, a mixer, an oscillator, a digital-to-analog converter (DAC), an analog-to-digital converter (ADC), and the like. Although FIG. 10 illustrates only one antenna, the UE may include a plurality of antennas. Further, the RF processing unit 10-10 may include a plurality of RF chains. Moreover, the RF processing unit 10-10 may perform beamforming. For the beamforming, the RF processing unit 10-10 may control a phase and a size of each of the signals transmitted/received through a plurality of antennas or antenna elements. The RF processing unit 10-10 may perform MIMO and receive a plurality of layers when the MIMO operation is performed.

The baseband processing unit 10-20 may perform a function of conversion between a baseband signal and a bitstream according to a physical layer standard of the system. For example, in data transmission, the baseband processing unit 10-20 generates complex symbols by encoding and modulating a transmission bitstream. In data reception, the baseband processing unit 10-20 may reconstruct a reception bitstream through demodulating and decoding of the baseband signal provided from the RF processing unit 10-10. For example, in an orthogonal frequency division multiplexing (OFDM) scheme, when data is transmitted, the baseband processing unit 10-20 may generate complex symbols by encoding and modulating a transmission bitstream, map the complex symbols to subcarriers, and then configure OFDM symbols through an inverse fast Fourier transform (IFFT) operation and a cyclic prefix (CP) insertion. Further, when data is received, the baseband processing unit 10-20 may divide the baseband signal provided from the RF processing unit 10-10 in the unit of OFDM symbols, reconstruct the signals mapped to the subcarriers through a fast Fourier transform (FFT) operation, and then reconstruct a reception bitstream through demodulation and decoding.

The baseband processing unit 10-20 and the RF processing unit 10-10 may transmit and receive signals as described above. Accordingly, each of the baseband processing unit 10-20 and the RF processing unit 10-10 may be called a transmitter, a receiver, a transceiver, or a communication unit. Further, at least one of the baseband processing unit 10-20 and the RF processing unit 10-10 may include a plurality of communication modules to support a plurality of different radio access technologies. At least one of the baseband processing unit 10-20 and the RF processing unit 10-10 may include different communication modules to process signals in different frequency bands. For example, the different radio access technologies may include a wireless LAN (for example, IEEE 802.11), a cellular network (for example, LTE), and the like. Further, the different frequency bands may include a super high frequency (SHF) (for example, 2.NRHz, NRhz) band and a millimeter (mm) wave (for example, 60 GHz) band.

The storage unit 10-30 may store data such as a basic program, an application program, and configuration information for the operation of the UE. Particularly, the storage unit 10-30 may store information related to a second access node performing wireless communication through a second radio access technology. The storage unit 10-30 may provide the stored data according to a request from the controller 10-40.

The controller 10-40 may control the overall operations of the UE. For example, the controller 10-40 may transmit and receive signals through the baseband processing unit 10-20 and the RF processing unit 10-10. Further, the controller 10-40 records data in the storage unit 10-40 and reads the data. To this end, the controller 10-40 may include at least one processor. For example, the controller 10-40 may include a communication processor (CP) that performs a control for communication, and an application processor (AP) that controls a higher layer such as an application.

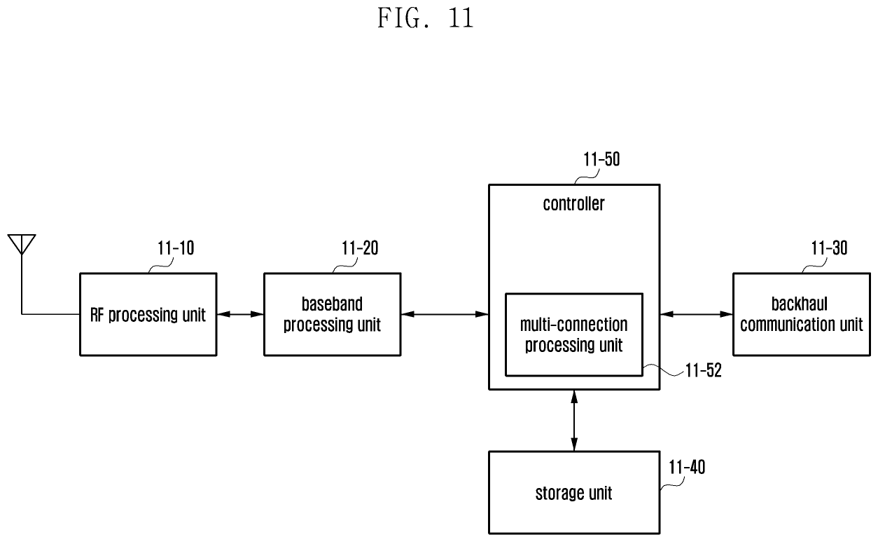

FIG. 11 is a block diagram illustrating the structure of the BS according to an embodiment of the disclosure.

Referring to FIG. 11, the BS may include an RF processing unit 11-10, a baseband processing unit 11-20, a backhaul communication unit 11-30, a storage unit 11-40, and a controller 11-50.

The RF processing unit 11-10 may perform a function of transmitting and receiving signals through a radio channel such as band conversion and amplification of a signal. The RF processing unit 11-10 may up-convert a baseband signal provided from the baseband processing unit 11-20 into an RF band signal, transmit the RF band signal through an antenna, and then down-convert an RF band signal received through an antenna into a baseband signal. For example, the RF processing unit 6-10 may include a transmission filter, a reception filter, an amplifier, a mixer, an oscillator, a DAC, an ADC, and the like. Although FIG. 11 illustrates only one antenna, the BS may include a plurality of antennas. Further, the RF processing unit 11-10 may include a plurality of RF chains. The RF processing unit 11-10 may perform beamforming. For the beamforming, the RF processing unit 11-10 may control the phase and the size of each of the signals transmitted and received through a plurality of antennas or antenna elements. The RF processing unit 11-10 may perform a downlink MIMO operation by transmitting one or more layers.

The baseband processing unit 11-20 may perform a function for conversion between a baseband signal and a bitstream according to physical layer standards of a first radio access technology. For example, in data transmission, the baseband processing unit 11-20 may encode and modulate a transmission bitstream to generate complex symbols. In data reception, the baseband processing unit 11-20 may reconstruct a reception bitstream through demodulating and decoding of the baseband signal provided from the RF processing unit 11-10. For example, in an OFDM scheme, when data is transmitted, the baseband processing unit 11-20 may generate complex symbols by encoding and modulating the transmission bitstream, map the complex symbols to subcarriers, and then configure OFDM symbols through an IFFT operation and CP insertion. In addition, when data is received, the baseband processing unit 11-20 divides a baseband signal provided from the RF processing unit 11-10 in units of OFDM symbols, reconstructs signals mapped with subcarriers through an FFT operation, and then reconstructs a reception bitstream through demodulation and decoding. The baseband processing unit 11-20 and the RF processing unit 11-10 may transmit and receive signals as described above. Accordingly, each of the baseband processing unit 11-20 and the RF processing unit 11-10 may be referred to as a transmitter, a receiver, a transceiver, a communication unit, or a wireless communication unit.

The backhaul communication unit 11-30 may provide an interface for communicating with other nodes within the network. The backhaul communication unit 11-30 may convert a bitstream transmitted from a main BS to another node, for example, an auxiliary BS, a core network, or the like into a physical signal and may convert the physical signal received from the other node into the bitstream.

The storage unit 11-40 may store data such as a basic program, an application program, and configuration information for the operation of the main BS. Particularly, the storage unit 11-40 may store information on bearers allocated to the accessed UE, a measurement result reported from the accessed UE, and the like. Further, the storage unit 11-40 may store information which is a reference for determining whether to provide or stop multiple connections to the UE. The storage unit 11-40 may provide the stored data according to a request from the controller 6-50.

The controller 11-50 may control overall operations of the BS. For example, the controller 11-50 may transmit and receive signals through the baseband processing unit 11-20 and the RF processing unit 11-10 or the backhaul communication unit 11-30. Further, the controller 11-50 records data in the storage unit 11-40 and reads the data. To this end, the controller 11-50 may include at least one processor.

Methods pertaining to the claims of the disclosure or embodiments disclosed in the specifications may be implemented in the form of hardware, software, or a combination of hardware and software.

When the methods are implemented in software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to the claims of the disclosure or embodiments stated in the specifications.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory including any combination of some or all thereof. Further, the number of configured memories may be plural.

In addition, the programs may be stored in an attachable storage device which may access through communication networks such as the Internet, an Intranet, a local area network (LAN), wide LAN (WLAN), and a storage area network (SAN), or communication networks constituted by a combination thereof. The storage device may access the device that implements embodiments of the disclosure through an external port. Further, a separate storage device in the communication network may access the device that implements embodiments of the disclosure.

In detailed embodiments of the disclosure, the components included in the disclosure have been expressed as a singular or plural form according to the proposed detailed embodiment. However, the singular or plural expression is selected appropriately for the situation presented for convenience of description, and the disclosure is not limited by a singular or plural components. Even components expressed in the plural form may be constructed in the singular form or even an component expressed in the singular form may be constructed in the plural form.

Meanwhile, although detailed embodiments have been described in the detailed description of the disclosure, various modifications can be made without departing from the scope of the disclosure. Therefore, the scope of the disclosure should not be defined as being limited to the embodiments, but should be defined by the appended claims and equivalents thereof.

1-14. (canceled)

15. A method performed by a user equipment (UE) in a communication system, the method comprising:
receiving, from a base station, a radio resource control (RRC) reconfiguration message including a lower layer triggered mobility (LTM) configuration, the LTM configuration including a list of at least one LTM candidate, each of the at least one LTM candidate including each of configuration information;
in case that a cell selection is triggered by detecting a radio link failure, identifying whether the LTM configuration includes information associated with an execution of an LTM cell switch, and identifying whether a selected cell based on the cell selection is associated with one of the at least one LTM candidate; and
in case that the LTM configuration includes the information associated with executing the LTM cell switch, and in case that the selected cell is associated with the one of the at least one LTM candidate, performing the LTM cell switch for the selected cell.

16. The method of claim 15, wherein the performing of the LTM cell switch further comprises:
applying configuration information of the selected cell among the at least one LTM candidate, for the selected cell.

17. The method of claim 16, further comprising:
transmitting, to the base station, an RRC complete message including an identifier (ID) associated with the selected cell.

18. The method of claim 17,
wherein the ID associated with the selected cell corresponds to the configuration information for the selected cell, and
wherein the radio link failure is associated with a primary cell (PCell).

19. A method performed by a base station in a communication system, the method comprising:
identifying a radio resource control (RRC) reconfiguration message including a lower layer triggered mobility (LTM) configuration, the LTM configuration including a list of at least one LTM candidate and information associated with an execution of an LTM cell switch, each of the at least one LTM candidate including each of configuration information;
transmitting, to a user equipment (UE), the RRC reconfiguration message; and
receiving, from the UE, an RRC complete message including an identifier (ID) associated with a selected cell.

20. The method of claim 19, wherein configuration information of the selected cell among the at least one LTM candidate, for the selected cell is applied by the UE.

21. The method of claim 19, wherein in case that a cell selection is triggered by a radio link failure detection by the UE and in case that the selected cell is associated with one of the at least one LTM candidate, the LTM cell switch for the selected cell is performed by the UE.

22. The method of claim 19,
wherein the ID associated with the selected cell corresponds to the configuration information for the selected cell, and
wherein a radio link failure is associated with a primary cell (PCell).

23. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, a radio resource control (RRC) reconfiguration message including a lower layer triggered mobility (LTM) configuration, the LTM configuration including a list of at least one LTM candidate, each of the at least one LTM candidate including each of configuration information,
in case that a cell selection is triggered by detecting a radio link failure, identify whether the LTM configuration includes information associated with an execution of an LTM cell switch, and identifying whether a selected cell based on the cell selection is associated with one of the at least one LTM candidate, and
in case that the LTM configuration includes the information associated with executing the LTM cell switch, and in case that the selected cell is associated with the one of the at least one LTM candidate, perform the LTM cell switch for the selected cell.

24. The UE of claim 23, wherein the instructions further cause the UE to:
apply configuration information of the selected cell among the at least one LTM candidate, for the selected cell.

25. The UE of claim 24, wherein the instructions further cause the UE to:
transmit, to the base station, an RRC complete message including an identifier (ID) associated with the selected cell.

26. The UE of claim 25,
wherein the ID associated with the selected cell corresponds to the configuration information for the selected cell, and
wherein the radio link failure is associated with a primary cell (PCell).

27. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
identify a radio resource control (RRC) reconfiguration message including a lower layer triggered mobility (LTM) configuration, the LTM configuration including a list of at least one LTM candidate and information associated with an execution of an LTM cell switch, each of the at least one LTM candidate including each of configuration information,
transmit, to a user equipment (UE), the RRC reconfiguration message, and
receive, from the UE, an RRC complete message including an identifier (ID) associated with a selected cell.

28. The base station of claim 27, wherein configuration information of the selected cell among the at least one LTM candidate, for the selected cell is applied by the UE.

29. The base station of claim 27,
wherein in case that a cell selection is triggered by a radio link failure detection by the UE and in case that the selected cell is associated with one of the at least one LTM candidate, the LTM cell switch for the selected cell is performed by the UE, and
wherein the ID associated with the selected cell corresponds to the configuration information for the selected cell, and
wherein the radio link failure is associated with a primary cell (PCell).
